(19) United States
(12) Patent Application Publication
(10) Pub. No.: US 2015/0369600 A1
(43) Pub. Date: Dec. 24, 2015

(54) TARGETING AUXILIARY SYSTEM FOR A RANGEFINDER

(71) Applicants: Yu-Cheng Li, Taichung City (TW); Cheng-Hsiung Ou, Taichung City (TW)

(72) Inventors: Yu-Cheng Li, Taichung City (TW); Cheng-Hsiung Ou, Taichung City (TW)

(21) Appl. No.: 14/308,717

(22) Filed: Jun. 19, 2014

(51) Int. Cl. G01C 3/08

(52) U.S. Cl. CPC G01C 3/08

(57) ABSTRACT

A targeting auxiliary system for a rangefinder comprises a range finding apparatus and an electronic device. The range finding apparatus has a first signal transmission unit. The electronic device is detachably connect with the range finding apparatus, and has a second signal transmission unit interconnected with the first signal transmission unit, a display electrically connected with the second signal transmission unit, and a lens connected with the display. The display has a focusing frame therein. For targeting an object, the focusing frame of the display is arranged to overlap a laser spot generated by the range finding apparatus and shown in the display such that the laser spot and the focusing frame are simultaneously aimed at the object.

### BACKGROUND OF THE INVENTION

1. Field of the Invention

The present invention relates to a laser rangefinder, and more particularly to a targeting auxiliary system for a laser rangefinder.

2. Description of Related Art

A laser rangefinder is a device which uses a laser beam to determine the distance to an object. The most common form of laser rangefinder operates on the time of flight principle by sending a laser pulse in a narrow beam toward the object and measuring the time taken by the pulse to be reflected off the target and returned to the sender.

Lasers are usually labeled with a safety class number, which identifies how dangerous the laser is. The laser rangefinder is generally used a class 2 laser which is safe during normal use. Although the laser spot from the laser rangefinder could be easily identified inside a room, the laser spot is hard to identify in the outdoor condition due to the surrounding brightness.

The present invention has arisen to mitigate and/or obviate the disadvantages of the conventional laser rangefinder.

### SUMMARY OF THE INVENTION

The main objective of the present invention is to provide an improved targeting auxiliary system for a laser rangefinder.

To achieve the objective, a targeting auxiliary system for a rangefinder comprises a range finding apparatus and an electronic device. The range finding apparatus has a first signal transmission unit. The electronic device is detachably connect with the range finding apparatus, and has a second signal transmission unit interconnected with the first signal transmission unit of the range finding apparatus, a display electrically connected with the second signal transmission unit, and a lens connected with the display. The display has a focusing frame therein. Specifically, means for targeting an object, the focusing frame of the display is arranged to overlap a laser spot generated by the range finding apparatus and shown in the display such that the laser spot and the focusing frame are simultaneously targeted at the object.

Preferably, the range finding apparatus is configured to measure a distance to the object and generate a distance value; and the distance value is transmitted from the first signal transmission unit to the second signal transmission unit and shown in the display.

Preferably, the range finding apparatus has at least one gripping portion for attachment to the electronic device detachably.

Preferably, the first signal transmission unit of the range finding apparatus and the second signal transmission unit of the electronic device are wire connected or wireless connected, wherein the electronic device is a mobile phone or a tablet.

Further benefits and advantages of the present invention will become apparent in the detailed description with appropriate reference to the accompanying drawings.

### BRIEF DESCRIPTION OF THE DRAWINGS

FIG. 1 is a block diagram of a targeting auxiliary system for a rangefinder in accordance with a preferred embodiment of the present invention;

FIG. 2 is an exploded perspective view for showing the range finding apparatus and the electronic device of the present invention;

FIG. 3 illustrates that the range finding apparatus is operated in a room, wherein the range finding apparatus is attached to the electronic device of the present invention;

FIG. 4 shows that a laser spot of the range finding apparatus is appeared in the display of the present invention;

FIG. 5 shows that a focusing frame of the display overlaps the laser spot of the range finding apparatus;

FIG. 6 illustrates that the range finding apparatus with the electronic device is operated outside; and

FIG. 7 shows that the focusing frame is targeted at an object in the display.

### DETAILED DESCRIPTION OF THE INVENTION

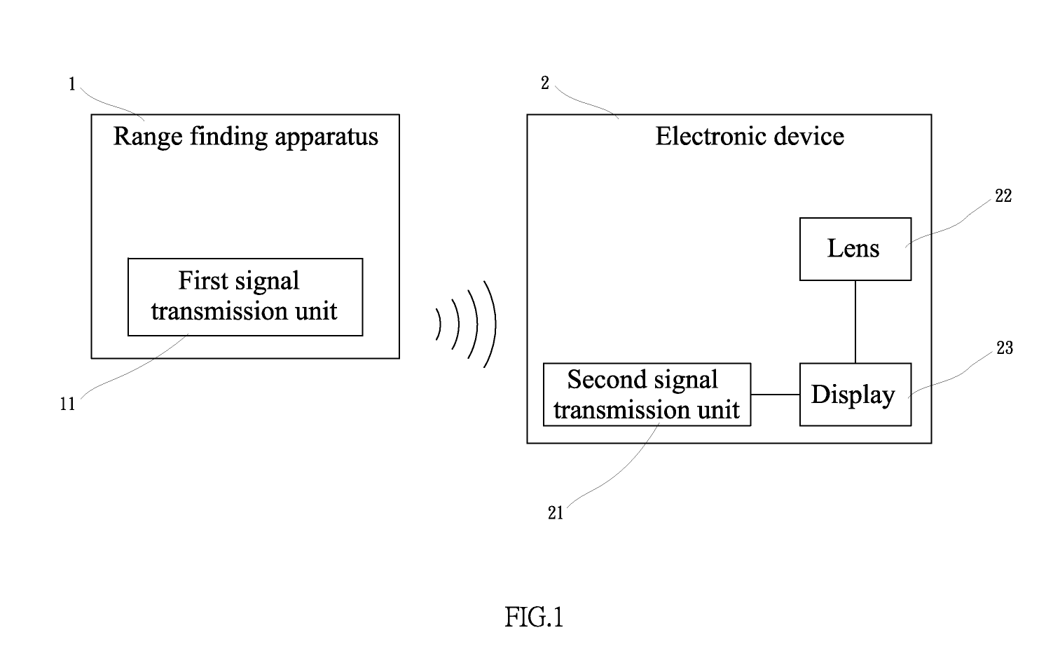

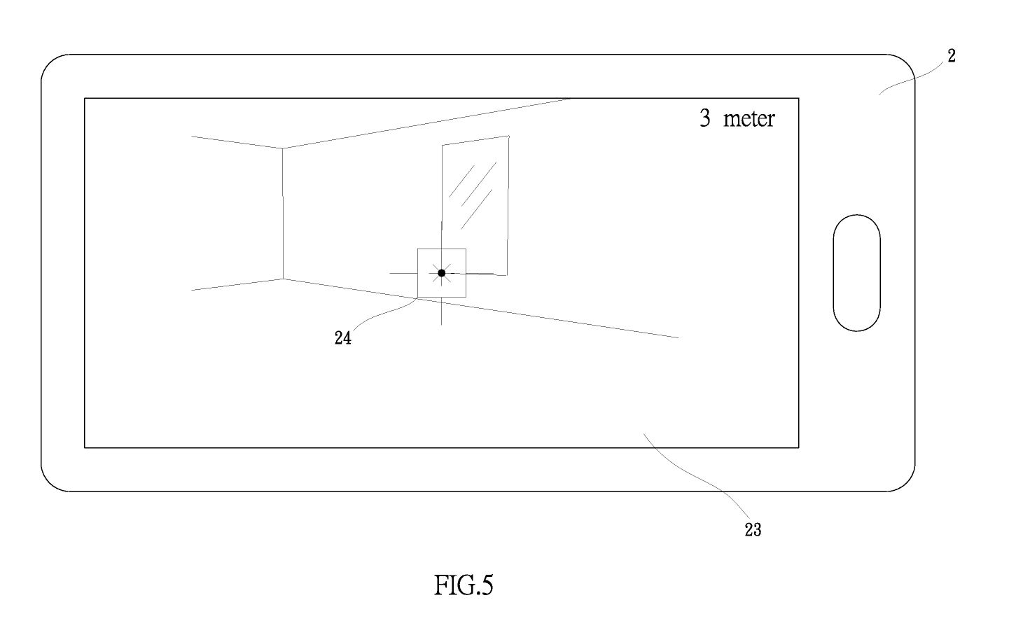

Referring to FIGS. 1-3, a targeting auxiliary system for a rangefinder in accordance with a preferred embodiment of the present invention comprises a range finding apparatus 1 and an electronic device 2. The range finding apparatus 1 is detachably mounted to the electronic device 2. The range finding apparatus 1 has a first signal transmission unit 11 and the electronic device 2 has a second signal transmission unit 21 interconnected with the first signal transmission unit 11 of the range finding apparatus 1. The electronic device 2 has a display 23 electrically connected with the second signal transmission unit 21, and a lens 22 connected with the display 23. The display 23 has a focusing frame 24 therein, as shown in FIG. 5.

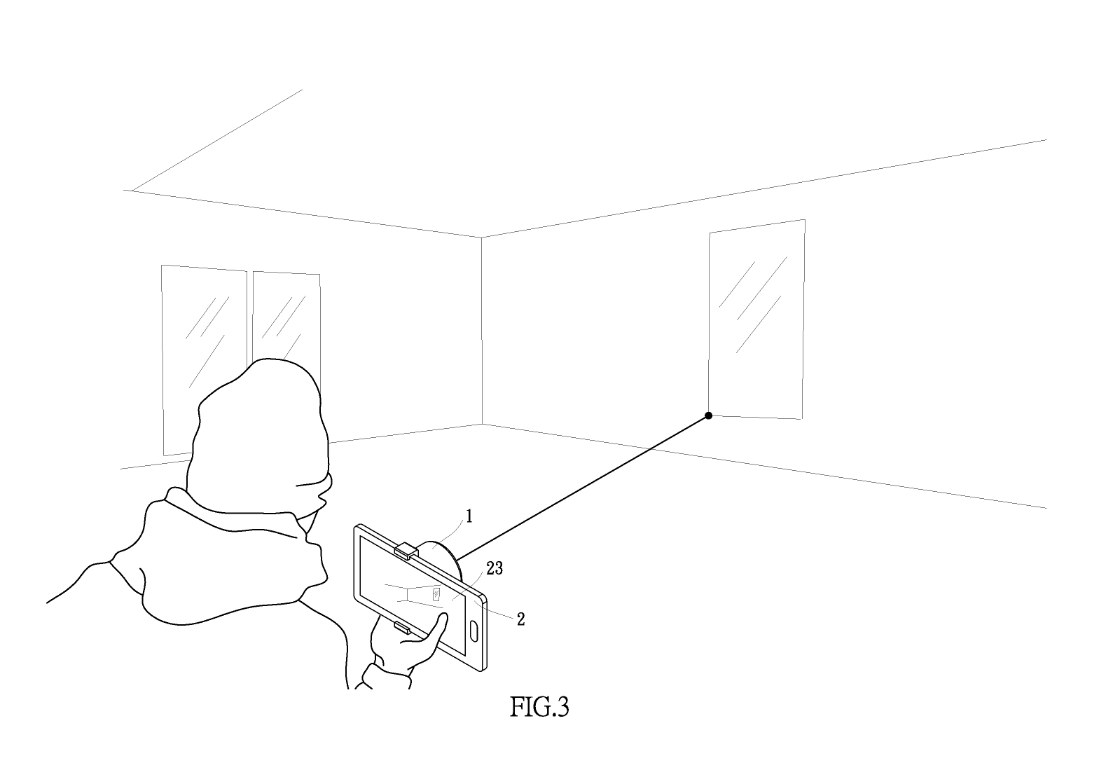

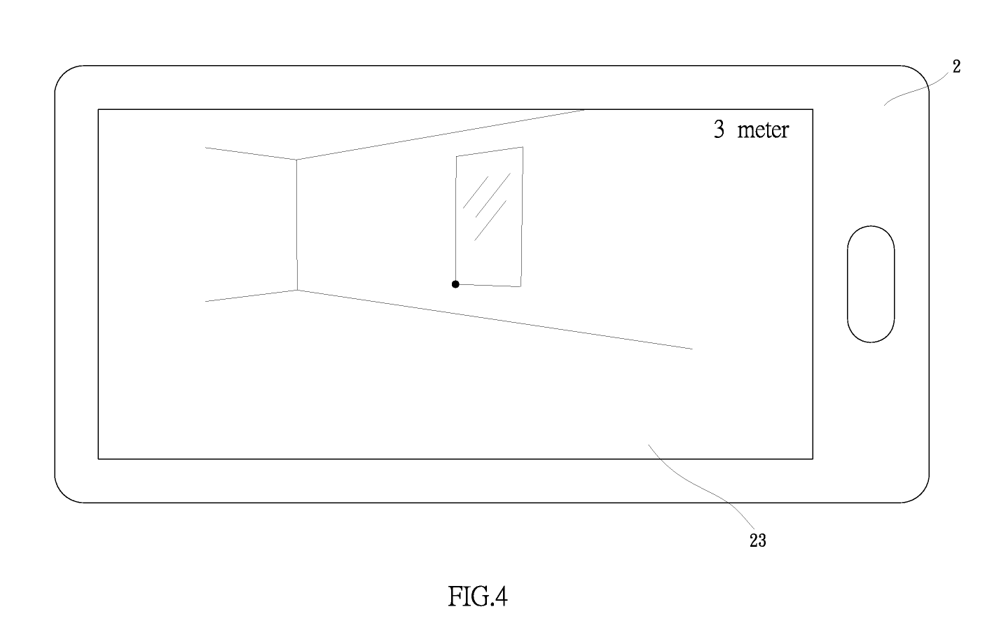

Referring to FIGS. 3-5, a laser spot generated by the range finding apparatus 1 could be shown in the display 23 of the electronic device 2 via the lens 22, as shown in FIG. 4. The focusing frame 24 of the display 23 is arranged to overlap the laser spot such that the laser spot and the focusing frame 24 are simultaneously aimed at an object, as shown in FIG. 5. Moreover, the range finding apparatus 1 is configured to measure a distance to the object and generate a distance value; and the distance value is transmitted from the first signal transmission unit 11 to the second signal transmission unit 21 and shown in the display 23.

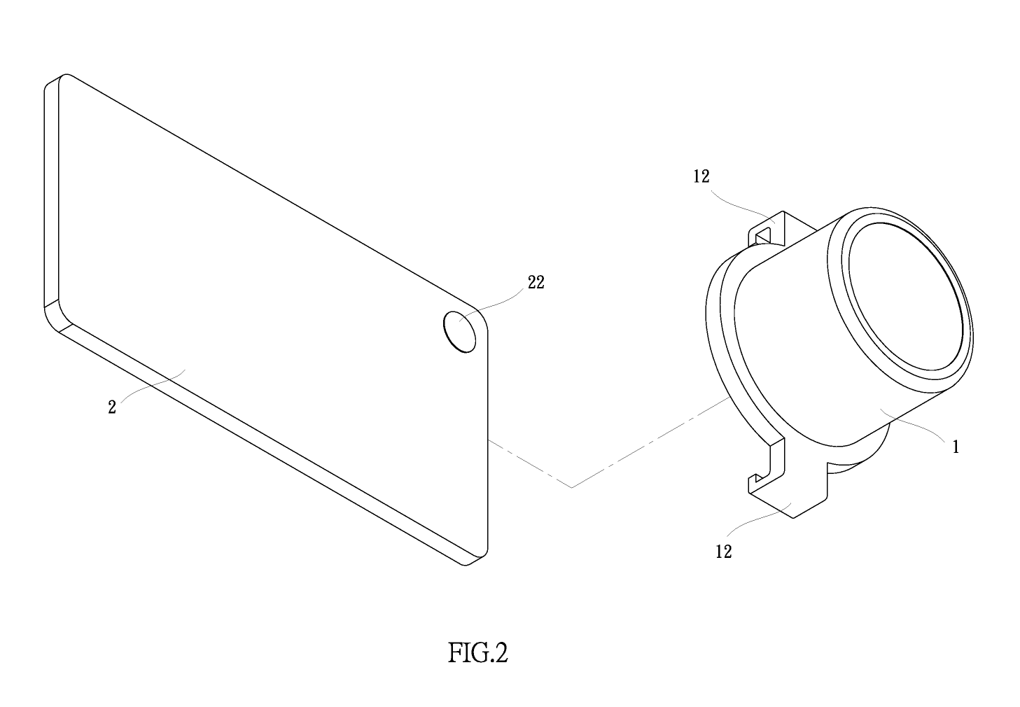

Furthermore, in the preferred embodiment of the present invention, the range finding apparatus 1 has two gripping portions 12 for attachment to the electronic device 2 detachably, as shown in FIG. 2. The electronic device 2 could be a mobile phone or a tablet with lens.

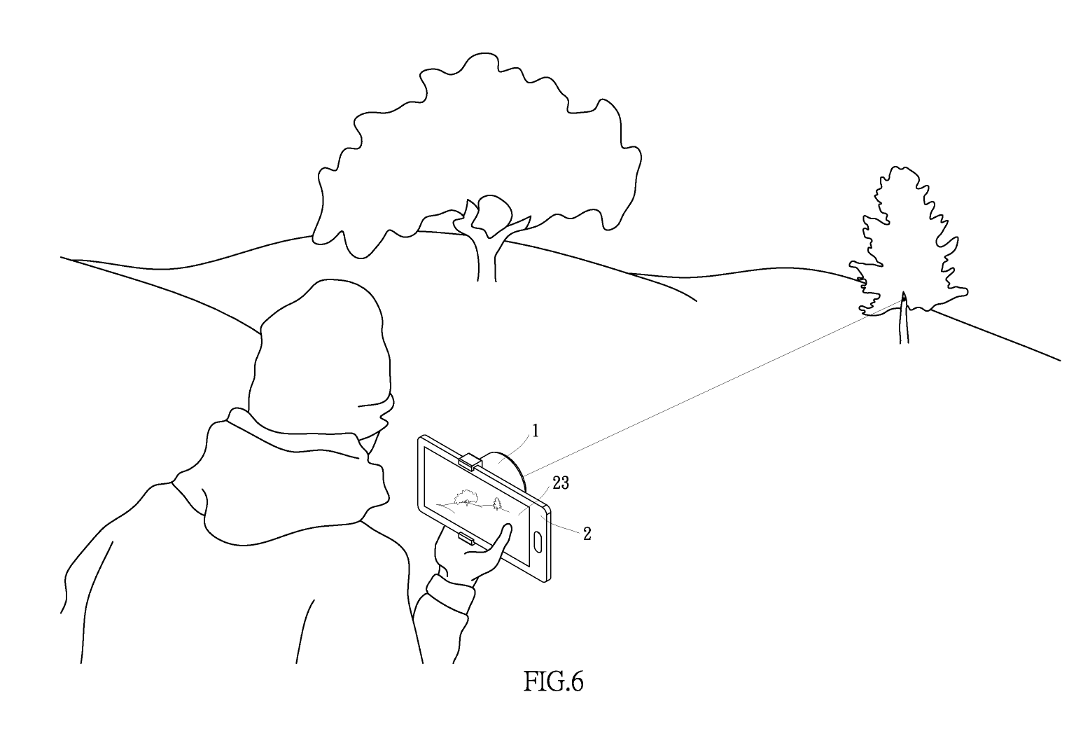

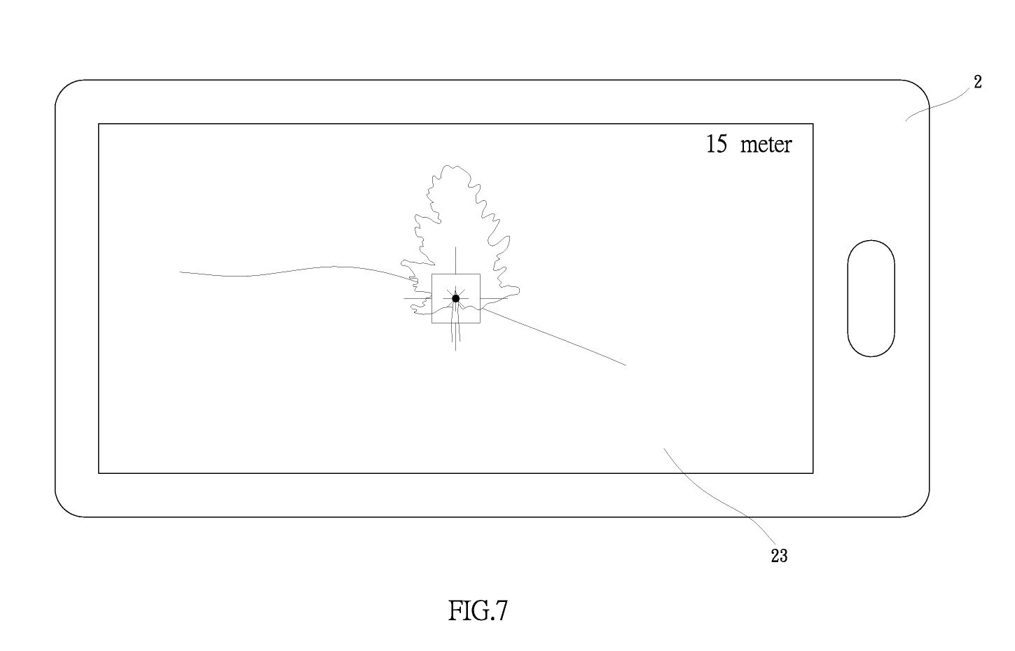

The range finding apparatus 1 combined with electronic device 2 could be used in an indoor condition and an outdoor condition. As shown in FIGS. 3-5, the range finding apparatus 1 is operated in the indoor condition, wherein the range finding apparatus 1 is aimed at one corner of a window and the measuring distance value is 3 meters. Specifically, an instant image could be shown in the display 23 of the electronic device 2 via the lens 22, and the laser spot of the range finding apparatus 1 is also shown in the display 23. The focusing frame 24 could be arranged to overlap the laser spot shown in the display 23 such that the laser spot and the focusing frame 24 could be aimed at the object simultaneously. When the range finding apparatus 1 is operated in the outdoor condition, the object could be aimed by the focusing frame 24 directly even though the laser spot may not be observed easily due to the surrounding brightness. As shown in FIGS. 6-7, the range finding apparatus 1 is operated to be aimed at a tree just by the focusing frame 24 shown in the display 23; and the measuring distance value is transmitted from the first signal transmission unit 11 to the second signal transmission unit 21 and shown in the display 23 such as 15 meters to the tree.

In addition, the first signal transmission unit 11 of the range finding apparatus 1 and the second signal transmission unit 21 of the electronic device 2 could be wire connected or wireless connected such as Bluetooth or Wi-Fi. For instance, a corresponding mobile APP (mobile application) program could be downloaded to the electronic device 2 for operation of the targeting auxiliary system.

Although the invention has been explained in relation to its preferred embodiment, it is to be understood that many other possible modifications and variations can be made without departing from the scope of the invention as hereinafter claimed.

What is claimed is:

1. A targeting auxiliary system for a rangefinder, comprising:
a range finding apparatus having a first signal transmission unit;
an electronic device detachably connect with the range finding apparatus, and having a second signal transmission unit interconnected with the first signal transmission unit of the range finding apparatus, a display electrically connected with the second signal transmission unit, and a lens connected with the display, the display having a focusing frame therein; and
means for targeting an object, the focusing frame of the display is arranged to overlap a laser spot generated by the range finding apparatus and shown in the display such that the laser spot and the focusing frame are simultaneously aimed at the object.

2. The targeting auxiliary system as claimed in claim 1, wherein the range finding apparatus is configured to measure a distance to the object and generate a distance value; and the distance value is transmitted from the first signal transmission unit to the second signal transmission unit and shown in the display.

3. The targeting auxiliary system as claimed in claim 1, wherein the range finding apparatus has at least one gripping portion for attachment to the electronic device detachably.

4. The targeting auxiliary system as claimed in claim 1, wherein the first signal transmission unit of the range finding apparatus and the second signal transmission unit of the electronic device are wire connected.

5. The targeting auxiliary system as claimed in claim 1, wherein the first signal transmission unit of the range finding apparatus and the second signal transmission unit of the electronic device are wireless connected.

6. The targeting auxiliary system as claimed in claim 1, wherein the electronic device is a mobile phone or a tablet.
